(19) United States
(12) Patent Application Publication
(10) Pub. No.: US 2008/0052299 A1
(43) Pub. Date: Feb. 28, 2008

(54) Reverse engineering support system

(75) Inventors: Hirofumi Shinke, Yokohama (JP); Takashi Kashimoto, Kawasaki (JP); Kazuyuki Aoyama, Akishima (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/701,312

(22) Filed: Jan. 31, 2007

(30) Foreign Application Priority Data
Aug. 22, 2006 (JP) 2006-224828

(51) Int. Cl. G06F 17/00

(52) U.S. Cl. 707/100

(57) ABSTRACT

A reverse engineering support system is provided which has a high abstract degree of an analysis target system and supports high level understanding. The reverse engineering support system stores a physical model which is a graph having as vertexes a program and input/output physical data, a business model which is a graph having as vertexes a business function and input/output logical data and an association model which is an association table indicating association of the business function with the program function and association of the logical data with the physical data, calculates a subgraph corresponding to the business function specified by a user by analyzing the corresponding physical model, displays a comparison with the subgraph of the physical model, and receives a modification order of the business and association models from the user.

### INCORPORATION BY REFERENCE

The present application claims priority from Japanese application JP 2006-224828 filed on Aug. 22, 2006, the content of which is hereby incorporated by reference into this application.

### BACKGROUND OF THE INVENTION

1. Field of the Invention

The present invention relates to a reverse engineering support system for analyzing a program used in an information system and assisting comprehension of the program.

2. Description of the Related Art

A conventional reverse engineering support has been used widely which analyzes a program used in an information system and supports comprehension of the program.

In general, however, specification extraction processing for extracting a specification of an information system through resource analysis is effective for the purpose of extracting low level specification information close to a computer system. However, the specification extraction processing is not effective for the purpose of extracting a high level specification close to business. This is because there is a limit in mechanically giving meaning to a program by conducting analysis. For business comprehension of an information system, it is necessary for a worker to conduct semantic analysis work on information obtained by analysis. As a technique for supporting such work, for example, the system in JP-A-09-101884 discloses a technique for supporting a worker in a process of adding semantic information to hierarchized information such as a module structure or a syntax structure of a program.

A set of processing programs that have meaning in business is not necessarily managed as a cluster of structures of an information system. There is a limit in such a way of giving meaning to existing structures. For example, it is considered that a series of instructions having meaning as a whole are written simply as a part of a source program and there are not especially syntax punctuations before and after the instructions.

Further, there are a case wherein one of different functions in the same program operates being selected by input data, a case wherein a plurality type of records having different meanings are stored in the same data storage area, and other cases. In such cases, it is considered that business meaning and information system architecture are not one-to-one correspondence.

### SUMMARY OF THE INVENTION

An object of the present invention is to provide a reverse engineering support system for supporting work of finding a set having business meaning constituted of elements of an information system on the basis of analysis results of reverse engineering and giving meaning to the set, to thereby support high abstract, high standard comprehension of the analysis target information system. Another object of the present invention is to provide a reverse engineering support system for supporting work of recognizing a plurality of meanings included in each element of an information system even if the business meaning and the element in the information system are not one-to-one correspondence.

The system of the present invention stores a physical model which is a graph having as vertexes a program to be analyzed and input/output physical data, a business model which is a graph having as vertexes a business function and input/output logical data and an association model which is an association table indicating association of the business function with the program function and association of the logical data with the physical data, calculates a subgraph corresponding to the business function specified by a user by analyzing the corresponding physical model, and in accordance with the subgraph, a set of programs corresponding to the business function and a set of physical data corresponding to the business input/output data.

The business model and association model are information input by the user. In the initial support state, information may be insufficient or does not match a real circumstance of a target system. However, comparison with the subgraph of the physical model is presented to the user, and the user modifies the business model and association model to support a process of improving a precision of the model. As an extension of this system, so as to allow the same physical data to store different logical data, the physical data is represented by a combination of a data storage area and a restriction to be satisfied by the data. In order to allow the same program to have different functions, the program function is represented by a combination of a program and a restriction to be satisfied by input data. In calculating the subgraph, integrity between these restrictive conditions are utilized. With this method, association of the business model with the physical model can be established even in the case where the same physical data stores different logical data and in the case where the same program contains different functions.

According to the present invention, while the business model and association model are modified, association of the business function of the business model with a set of programs of the physical model is established to thereby support reverse engineering on the basis of understanding the whole target system.

Other objects, features and advantages of the invention will become apparent from the following description of the embodiments of the invention taken in conjunction with the accompanying drawings.

### BRIEF DESCRIPTION OF THE DRAWINGS

FIG. 1 is a system configuration diagram of a business specification generation support system according to an embodiment of the present invention.

FIG. 2 is a diagram showing graphical structures of a business model 24, a physical model 22 and an association model 23.

FIG. 3 is a diagram showing an example of data structures of the physical model 22.

FIG. 4 is a diagram showing an example of a data structure of the business model 24.

FIG. 5 is a diagram showing an example of data structures of the association model 23.

FIG. 6 is a flow chart showing an outline of processing of the present system.

FIG. 7 is a flow chart showing in detail processing conducted at Step 104 shown in FIG. 6.

FIG. 8 shows an example of a subgraph selected by data driven analyzing shown in FIG. 7.

FIG. 9 is a diagram showing a screen example of a result obtained by conducting processing shown in FIG. 7 and displayed on a display apparatus.

FIG. 10 is a diagram showing another screen example of a result obtained by conducting processing shown in FIG. 7 and displayed on a display apparatus.

FIG. 11 is a flow chart showing processing conducted at Step 116 to judge a connected component of a subgraph.

FIG. 12 is a flow chart showing in detail processing conducted at Step 105 shown in FIG. 6.

FIG. 13 shows an example of a subgraph selected by function driven analyzing shown in FIG. 6.

FIG. 14 is a diagram showing examples of data tables of an extended physical model when restrictions are imposed upon program functions and physical data.

FIG. 15 is a diagram showing examples of data tables of an association model when restrictions are imposed upon program functions and physical data.

FIG. 16 is a diagram illustrating processing tracing program function vertexes by using physical data in the extended model with restrictions.

FIG. 17 is a diagram illustrating processing tracing physical data vertexes by using program functions in the extended model with restrictions.

FIG. 18 is a diagram illustrating processing of evaluating the condition to be satisfied by an output item of a program function by using the condition imposed on an input item of the program function, in the extended model with restrictions.

FIG. 19 is a diagram showing a result of mapping processing when a condition is imposed on FILE-a in the extended model with restrictions.

FIG. 20 is a diagram showing a result of mapping processing when a condition is imposed on FILE-a and an input item of PGM-x in the extended model with restrictions.

FIG. 21 is a diagram showing a result of mapping processing when a condition is imposed on FILE-a, an input item of PGM-x and an output condition in the extended model with restrictions.

FIG. 22 is a diagram showing a result of mapping processing when a condition is imposed on FILE-a, an input item of PGM-x, an output condition and FILE-n in the extended model with restrictions.

FIG. 23 is a diagram showing a result of mapping processing when work of “domestic order receiving registration processing” is completed in the extended model with restrictions.

### DESCRIPTION OF THE EMBODIMENT

Embodiments of the present invention will now be described in detail with reference to the accompanying drawings.

### First Embodiment

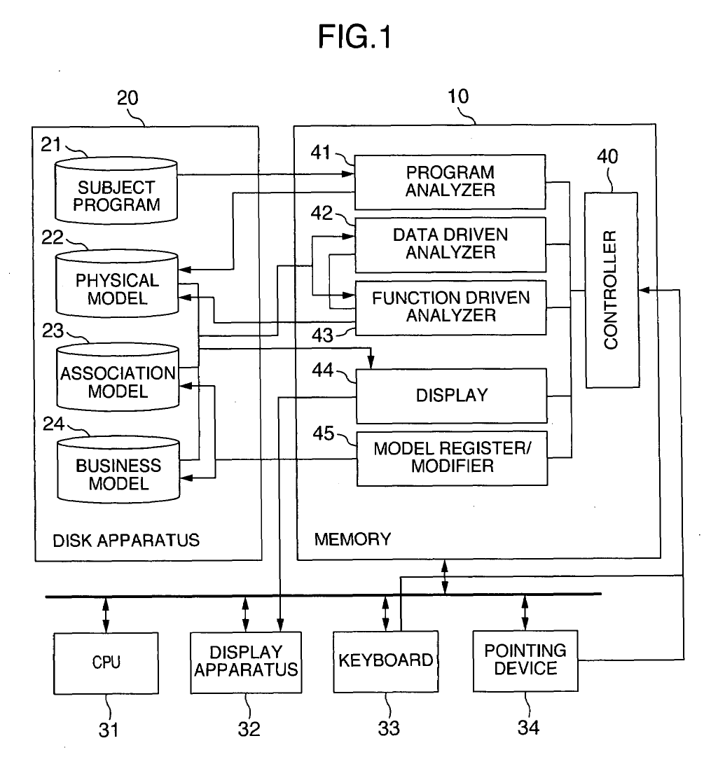

FIG. 1 is a system configuration diagram of a reverse engineering support system of the present invention.

FIG. 1 is a system configuration diagram of a business specification generation support system according to the embodiment of the present invention. This present system includes a CPU 31, a display apparatus 32, a keyboard 33, a pointing device 34 such as a mouse, a disk apparatus 20, and a memory 10. The memory 10 stores programs for a controller 40, a program analyzer 41, a data driven analyzer 42, a function driven analyzer 43, a display unit 44 and a model register/modifier 45, which are connected each other via a bus or the like. The disk apparatus 20 stores databases for a subject program 21, a physical model 22, an association model 23 and a business model 24.

The subject program 21 is a set of programs that are analysis subjects of the system shown in FIG. 1. Here, the “program” means an arbitrary description that defines a procedure, such as a description of a job control language, the whole of a source program written using a general purpose language, or its part such as a function and a procedure. In particular, a sequence of specific executable statements in a program depending upon the environment at the time of execution and the value of input data may be defined as a “program”.

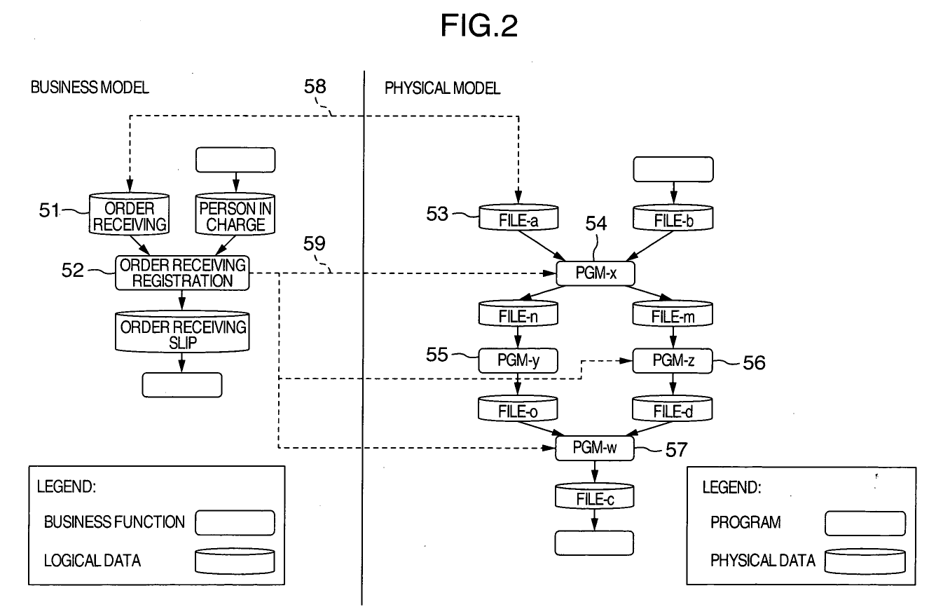

FIG. 2 is a diagram showing graphical structures of the physical model 22 and business model 24. In the graphical structure of the physical model (shown on the right-hand side of FIG. 2), the vertex of the graph is a program 54 or physical data 53. The physical data 53 is arbitrary one such as a record, a variable, a file and a table in a program which stores a set of records. The program vertex and the physical data vertex are connected each other by a directed edge to represent an input or output of data. Information of such graphical structures can be obtained by analyzing the subject program 21 with the conventional program analysis technique.

The graphical structure of the business model (shown on the left side of FIG. 2) has a structure similar to that of the physical model. The vertex of the graph is a business function 52 or logical data 51. The business model and association model are in put by the user at the time of start of system analysis, and thereafter modified by the user on the basis of a difference from a physical model indicated by the function driven analyzer 43 and data driven analyzer 42. As the initial business model, a rough model that can be known by the user may be used, or a business system or a standard model in the type of application may be used. As the initial association model, an already known rough model may be used.

By the way, in the physical model 22 and business model 24 shown in FIG. 2, it is supposed that there are no loops along arrows and the execution order of the programs runs along the direction of arrows. Such a supposition typically holds true in a batch system (execution programs and files). In addition, the supposition holds true even in on-line systems or the like, as long as a sequence of executed programs is evaluated and the instance of data is provided with a distinction every update.

In the present embodiment, association of the physical model 22 wit the business model 24 is managed using the association model 23. The association model 23 is represented by dotted lines 58 and 59 in FIG. 2. A data structure of the association model 23 is shown in FIG. 5 to be described later.

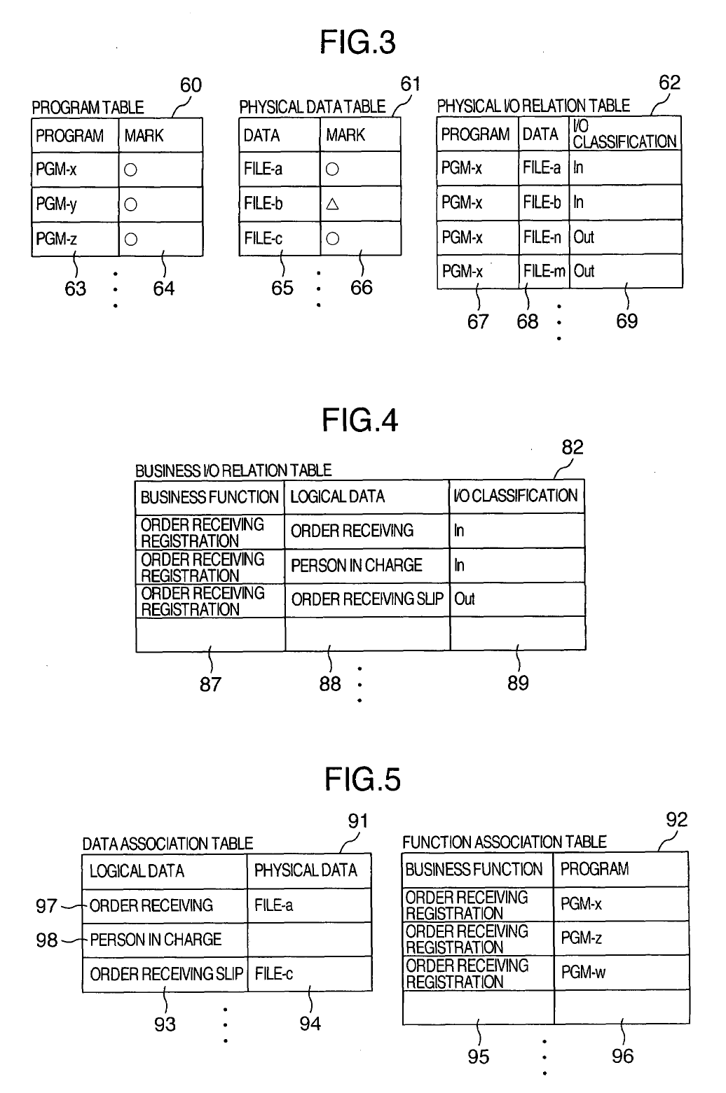

FIG. 3 is a diagram showing a data structure example of the physical model 22. A program table 60 and a physical data table 61 shown in FIG. 3 are used to record work state concerning a program 63 and physical data 65 respectively in mark columns 64 and 66 in a retrieval algorithm to be described later. In the initial state of processing, the mark columns 64 and 66 are cleared to become null. A physical I/O relation table 62 shown in FIG. 3 defines an actual graphic structure (input-output relations between a program 67 and physical data 68). For example, a record 71 indicates that physical data FILE-a is input data to a program PGM-x.

FIG. 4 is a diagram showing a data structure example of the business model 24. A business I/O relation table 82 defines a graphical structure (logical data 88 corresponding to a business function 87 and an I/O classification 89 indicating whether the logical data is input data or output data).

FIG. 5 is a diagram showing a data structure example of the association model 23. The diagram includes a data association model 91 showing association of logical data 93 with physical data 94 and a function association table 92 showing association of a business function 95 with a program 96. For example, a record 97 in the data association model 91 indicates that logical data “order receiving” is associated with physical data “FILE-a” (it corresponds to a dotted line 58 shown in FIG. 2). In the function association model 92, a business function “order receiving registration” is associated with three programs “PGM-x, PGM-z, PGM-w” (they correspond to dotted lines 59 shown in FIG. 2).

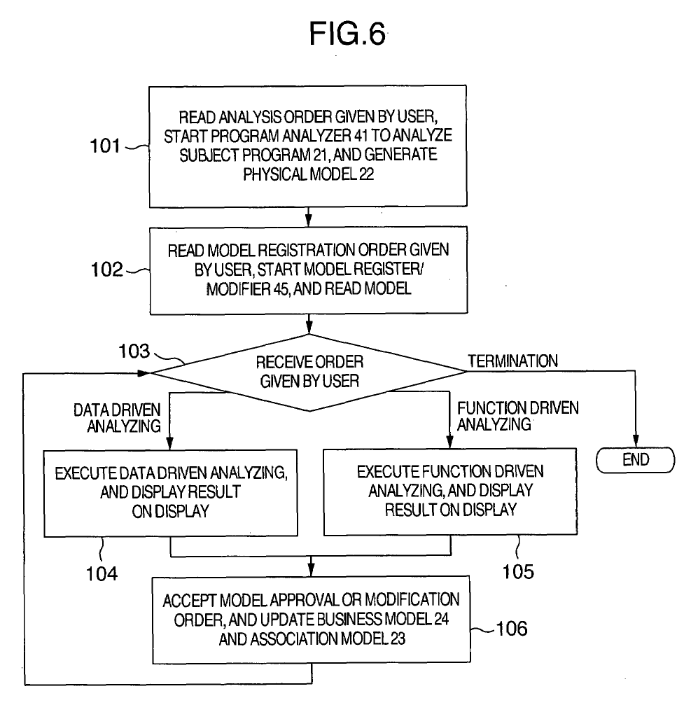

FIG. 6 is a flow chart showing an outline of processing conducted by the system shown in FIG. 1.

First, the controller 40 reads an analysis order given by the user and input from the keyboard 33 or pointing device 34, starts the program analyzer 41 to analyze the subject program 21, and generates the physical model 22 (Step 101). Subsequently, the controller 40 reads a model registration order input by the user, and starts the model register/modifier 45. The model register/modifier 45 reads the business model and association model input by the user, and registers the business model 24 and association model 23 (Step 102). Subsequently, the controller 40 makes a decision whether the order given by the user is data driven analyzing, function driven analyzing or termination (Step 103).

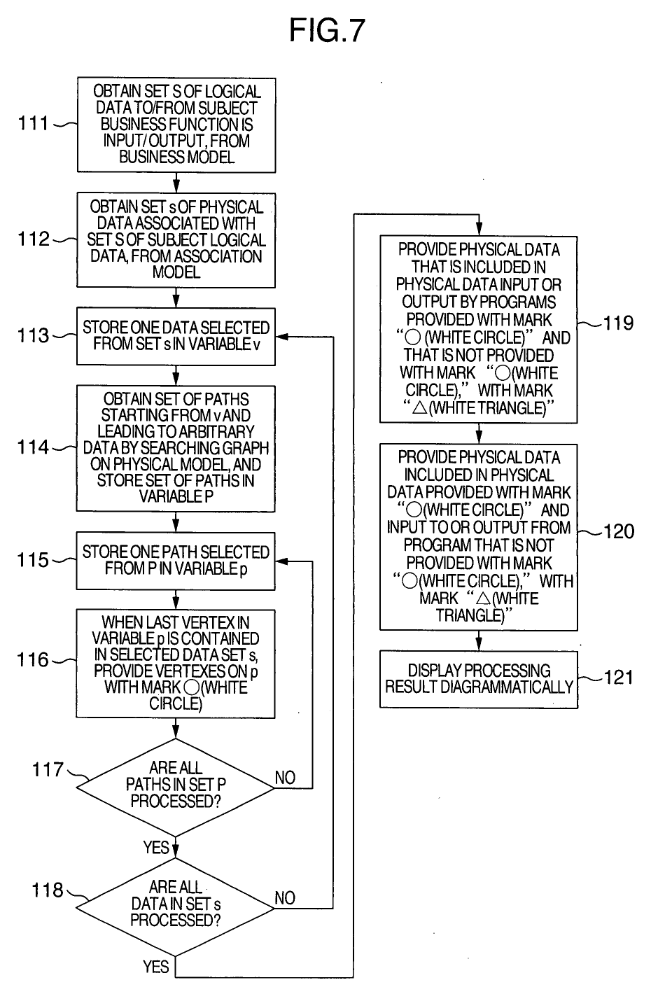

If the order given by the user is “data driven analyzing” as a result of the decision made at Step 103, then the controller 40 starts the data driven analyzer 42 for a business function specified by the user, and displays a result of processing on a screen (Step 104). Here, the data driven analyzing is processing of extracting a subgraph associated with the specified business function from the physical model, with data of the business model/association model taken as the starting point. Details of Step 104 will be described later with reference to FIG. 7.

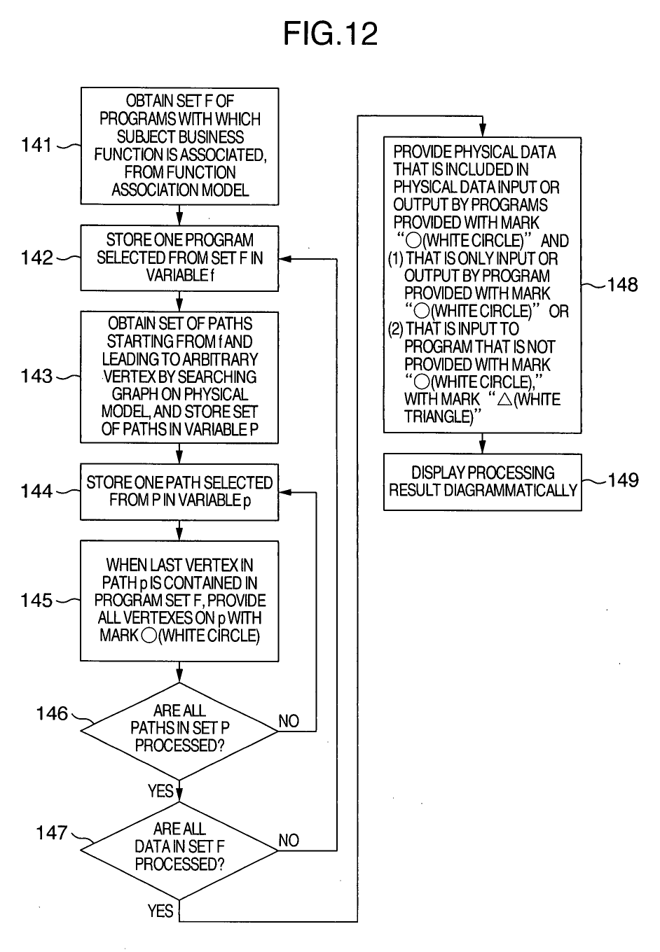

If the order given by the user is “function driven analyzing” as a result of the decision made at Step 103, then the controller 40 starts the function driven analyzer 43 for a business function specified by the user, and displays a result of processing on the screen (Step 105). Here, the function driven analyzing is processing of extracting a subgraph associated with the specified business function from the physical model, with a function portion of the business model/association model taken as the starting point. Details of Step 105 will be described later with reference to FIG. 12.

An input conducted by the user as to whether modification is necessary and a modification method is accepted on the view displayed on the screen at Step 104 or 105. Upon receiving this input, the controller 40 updates the associated business model or association model of the user (Step 106), and returns to the state in which an order is accepted (Step 103). By thus repeating the process of Steps 103 to 106, the user ascertains the difference between the business model and physical mode, and gives a modification order. As a result, precisions of the business model and association model can be gradually raised.

FIG. 7 is a flow chart showing details of Step 104 (data driven analyzing) shown in FIG. 6.

First, the data driven analyzer 42 conducts retrieval in the business function column 87 in the business I/O relation table 82 included in the business model 24, and thereby obtains a set S of relating logical data (Step 111). For example, if the business function specified by the user is “order receiving registration”, the data driven analyzer 42 conducts retrieval in the business function column 87 in the business I/O relation table 82 by using “order receiving registration” as a key, obtains a set S containing three logical data “order receiving”, “person in charge”, and “order receiving slit”, and stores the set S in a storage area in the memory 10.

Subsequently, the data driven analyzer 42 conducts retrieval in the logical data column 93 in the data association model 91 (FIG. 5) by using the set S of logical data extracted at Step 111 as a key, and obtains a set s of physical data associated with the set of subject logical data (Step 112). For example, the set S of logical data obtained at Step 111 is S={order receiving, person in charge, order receiving slip}. Therefore, the data driven analyzer 42 conducts retrieval in the logical data column 93 in the data association model 91 by using elements of the set S as a key, and obtains a set s={FILE-a, FILE-c} of physical data (in the example shown in FIG. 5, the case where physical data associated with the logical data “person in charge” is unknown is supposed). In addition, the data driven analyzer 42 stores the s in a storage area in the memory 10.

Subsequently, the data driven analyzer 42 selects one data from the set s of physical data obtained at Step 112, and stores the data in a variable v contained in a storage area in the memory 10 (Step 113). Subsequently, the data driven analyzer 42 conducts retrieval in a direction of arrows along edges of a graph on the physical model by taking physical data specified by the variable v as the starting point, obtains a set of paths starting from the physical data v and leading to arbitrary data on the graph, and stores the set of the paths in a variable P contained in a storage area in the memory 10 (Step 114). For example, supposing FILE-a in the graph showing in FIG. 2 to be the starting point, the set P of paths obtained at Step 114 becomes P={(FILE-a), (FILE-a→PGM-x→FILE-n), (FILE-a→PGM-x→FILE-m), (FILE-a→PGM-x→FILE-n→PGM-y→FILE-o), (FILE-a→PGM-x→FILE-m→PGM-z→FILE-d), (FILE-a→PGM-x→FILE-n→PGM-y→FILE-o→PGM-w→FILE-c), and (FILE-a→PGM-x→FILE-m→PGM-z→FILE-d→PGM-w→FILE-c).

Subsequently, the data driven analyzer 42 stores one path selected from the variable P obtained at Step 114 in a variable p contained in a storage area in the memory 10 (Step 115). If the last vertex in the variable p is contained in the data set s obtained at Step 112, all vertexes on the path p selected at Step 115 are provided with ◯ (Step 116). Here, vertexes mean physical data and programs included in a certain path. For example, as for “FILE-a→PGM-x→FILE-n→PGM-y→FILE-o→PGM-w→FILE-c”, the last vertex “FILE-c” is contained in the set s. With respect to “FILE-a, PGM-x, FILE-n, PGM-y, FILE-o, PGM-w and FILE-c” which are vertexes on this path, therefore, “◯” is stored in the mark columns 64 and 66 of associated records in the program table 60 and the physical data table 61 (FIG. 3).

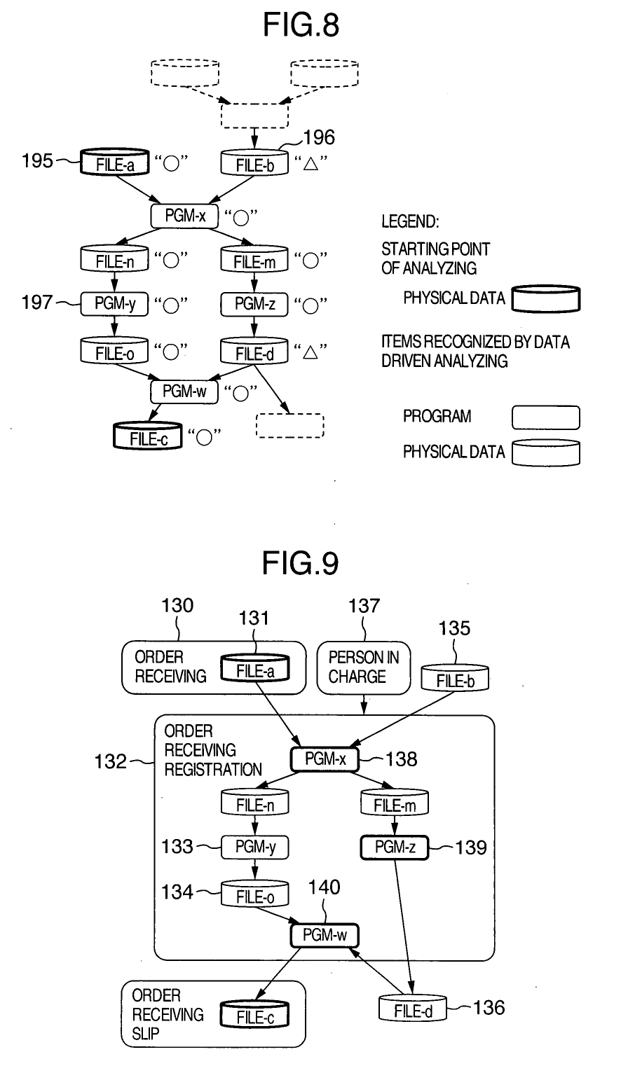

Processing at Steps 115 and 116 is conducted on all paths contained in the variable P obtained at Step 114 (Step 117). In addition, processing at Steps 113 to 117 is conducted on all physical data contained in the set s obtained at Step 112 (Step 118). For example, if processing is executed on the graph shown in FIG. 8 taking {FILE-a, FILE-c} as a set at the start point of physical data, then “◯” is stored in the mark columns 64 and 66 associated with “FILE-a, PGM-x, FILE-n, FILE-m, PGM-y, PGM-z, FILE-o, FILE-d, PGM-w, and FILE-c” in the program table 60 and the physical data table 61.

Subsequently, the data driven analyzer 42 provides physical data that is included in physical data input or output by programs provided with “◯” at Step 116 and that is not provided with the mark “◯”, with a mark “Δ” (Step 119). In the example shown in FIG. 8, the FILE-b comes under the condition (an input program of the FILE-b is not provided with the mark “◯”). The mark “Δ” is stored in the mark column 66 of a record associated with the “FILE-b” in the physical data table 61. It is inferred that a specified business function is input to and output from this vertex “FILE-b”. However, the vertex “FILE-b” is lacking in the business model and association model at the current point in time.

Subsequently, the data driven analyzer 42 provides physical data included in physical data provided with the mark “◯” at Step 116 and input to or output from a program that is not provided with the mark “◯” and a mark “Δ” (Step 120). In the example shown in FIG. 8, the physical data FILE-d comes under the condition (there is another program having the physical data FILE-d as input data, besides the PGM-w). It is inferred that a specified business function is input to and output from this vertex. However, this vertex is lacking in the business model and association model at the current point in time. FIG. 8 shows vertexes provided with marks by the data driven analyzing. They represent a subgraph recognized by the data driven analyzing conducted at Steps 111 to 121 shown in FIG. 7.

Finally, the display unit 44 transmits a subgraph of a result of processing conducted up to Step 120 to the display apparatus. The display apparatus diagrammatically displays the subgraph of the result of processing (Step 121). FIG. 8 shows vertexes provided with marks by the data driven analyzing. At this time, information representing relation to the business model is also displayed together. It is indicated whether a program contained in the subgraph and physical data located at ends of the subgraph matches the business model/association model.

FIG. 9 shows a screen example of the processing result displayed at Step 121 shown in FIG. 7. A frame line 130 represents logical data “order receiving”. A FIG. 131 indicating physical data FILE-a surrounded by a frame line 130 indicates that the logical data “order receiving” and the physical data FILE-a are represented by the association model (the record 97 in the data association table 91 shown in FIG. 5). On the other hand, lack of such a frame in FIGS. 135 and 136 respectively representing physical data FILE-b and FILE-d indicates that they are not associated with the business models (FIG. 5). Lack of a figure representing physical data inside a frame line 137 representing logical data “person in charge” indicates that physical data associated with the logical data “person in charge” is unknown, that is, information representing associated physical data is not present inn the data association model (a record 98 in the data association model 91 shown in FIG. 5).

A frame line 132 represents a business function “order receiving registration”. Figures indicating physical data and programs surrounded by the frame line 132 represent physical data and programs processed by the data driven analyzing (FIG. 7). For example, FIGS. 138, 139 and 140 respectively associated with programs PGM-x, PGM-z and PGM-w are highlighted because they coincide with the association model at the current point in time. A FIG. 133 associated with PGM-y is not highlighted because the PGM-y is a program processed by the data driven analyzing, but the PGM-y is not associated with the business model.

The user ascertains such a screen, and makes a decision as to whether modification is necessary and as to the modification method. For example, the user's modification order supposed in the example shown in FIG. 9 is as follows:

(1) Associate the program PGM-y with the business function “order receiving registration”.

(2) Associate the physical data FILE-b with logical data “person in charge”.

(3) Register logical data “inquiry about appointed date of delivery” in business model as new output data, and associate the physical data FILE-d with the logical data “inquiry about appointed date of delivery”.

The controller 40 reads such an order given by the user, from the pointing device 34 such as a mouse. The data driven analyzer 42 conducts update processing of the business model and association model at Step 116 in FIG. 7. FIGS. 8 and 9 show examples of the case where logical data is lacking in the business model or association model is unknown even if logical data is recognized.

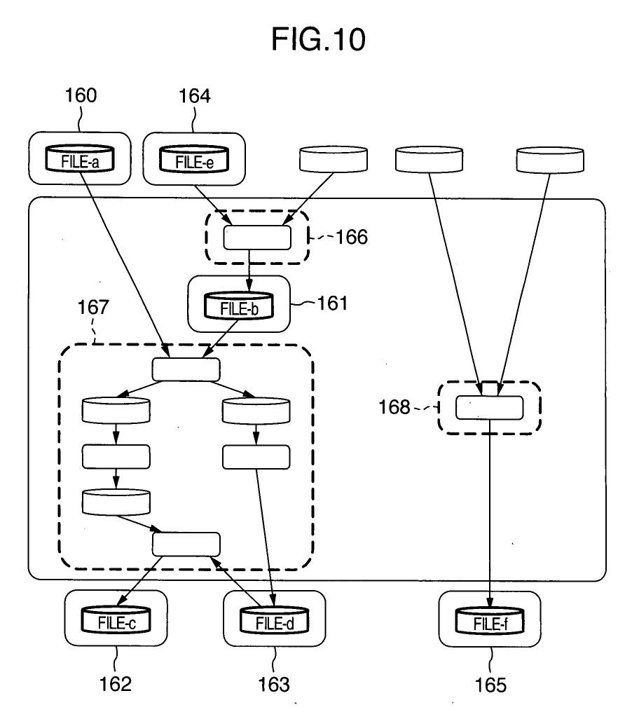

FIG. 10 is an example showing another pattern of the business model and the physical model. It is now supposed that the physical data “FILE-e” 164 and “FILE-f” 165 are additionally specified as shown in FIG. 10, although four physical data “FILE-a” 160, “FILE-b” 161, “FILE-c” 162 and “FILE-d” 163 are required originally. If the data driven analyzing (FIG. 7) is conducted in such a situation, a graph is divided into a plurality of graphs having a subset in a specified set of physical data as a vertex at an end. Such subgraphs are represented by dotted frame lines 166, 167 and 168 in FIG. 10. In other words, in FIG. 10, whether some physical data is incorporated in a business flow or has no relation to a business flow is discriminated on the screen.

Subgraphs as shown in FIG. 10 can appear not only in the case where extra data is incorporated in the business model, but also in the case where the grain of the business function in the business model is coarse as compared with the actual grain and more detailed division is possible. Discrimination of such a subgraph can be conducted by placing an identifier, which represents a connected component of the graph, in a mark column when providing marks in the data driven analyzing.

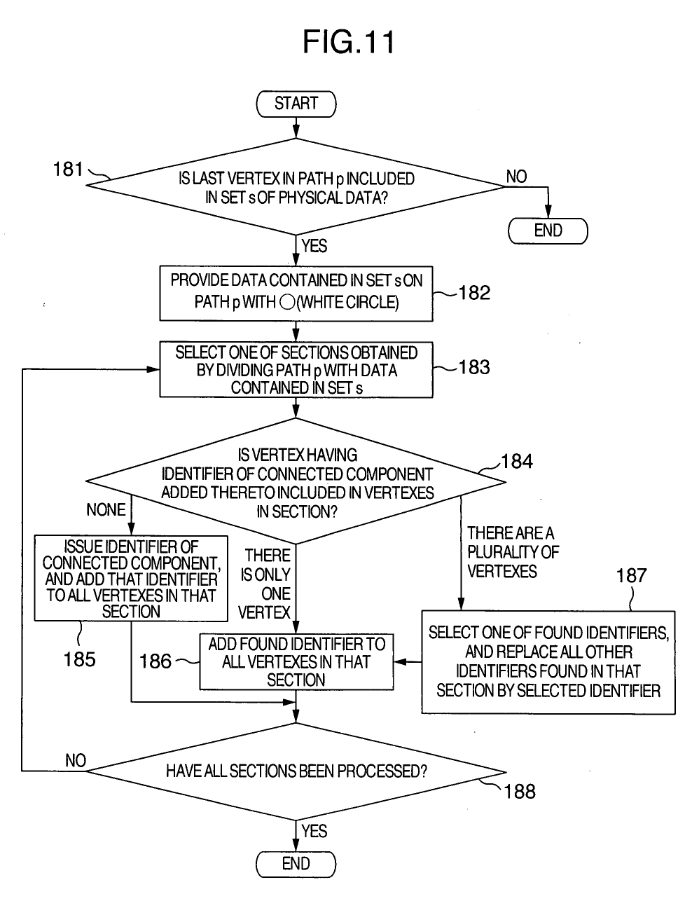

FIG. 11 is a flow chart showing processing conducted at Step 116 in the data driven analyzing (FIG. 7) with the data and graph shown in FIG. 10.

First, the data driven analyzer 42 makes a decision whether the last vertex in the path p is included in the specified set s of physical data (Step 181). If the last vertex in the path p is not included, the processing is finished. If the last vertex in the path p is included, the data driven analyzer 42 stores ◯ in the mark column 66 in the physical data table 61 associated with vertexes that are elements of the set s of physical data contained on the path p (Step 182), and selects one of sections obtained by dividing the path p with elements of the set s (Step 183).

The data driven analyzer 42 examines vertexes in the section selected at Step 183, and determines whether a vertex having an identifier of a connected component added thereto is included in the vertexes (Step 184). If a vertex having an identifier added thereto is not present, the data driven analyzer 42 issues a new identifier, and adds the new identifier to all vertexes in that section (Step 185). If a vertex having an identifier added thereto is present and only one identifier is used in the whole section, the data driven analyzer 42 adds this identifier to all vertexes in the section (Step 186). If there are a plurality of identifiers in this section, the data driven analyzer 42 selects one of the identifiers and replaces other identifiers with the selected identifier (Step 187). By the way, the identifier replacing processing is conducted on the whole physical model. Thereafter, the data driven analyzer 42 adds the selected identifier to all vertexes in the subject section (Step 186).

Until an unprocessed section on the path p disappears, the data driven analyzer 42 conducts the processing of Steps 183 to 187 (Step 188). Owing to the processing heretofore described, it is possible to set an identifier for vertexes inside the subgraph every connected component, and display as shown in FIG. 10. By displaying the dotted lines shown in FIG. 10 on the display apparatus, the user can ascertain extra specified data and divisible business function, and give the following orders:

(1) Delete a business model and an association model associated with the physical data FILE-e.

(2) Delete a business model and an association model associated with the physical data FILE-f.

(3) Divide the business function into ranges surrounded by the frame lines 166, 167 and 168, and associate programs contained in the ranges with functions obtained by the division.

The controller 40 reads such an order given by the user, from the pointing device 34 such as a mouse. The data driven analyzer 42 conducts update processing of the business model and association model at Step 116 in FIG. 7.

FIG. 12 is a flow chart showing details of the processing (function driven analyzing) conducted at Step 105 in FIG. 6.

First, the function driven analyzer 43 conducts retrieval in the business function column 95 in the function association table 92 by using a business function specified by the user, and thereby obtains a set F of programs with which the subject business function is associated (Step 141). For example, if the specified business function is “order receiving registration”, contents of the set F become F={PGM-x, PGM-z, PGM-w} as shown in FIG. 5.

Subsequently, the function driven analyzer 43 selects one program from the set F, and stores the program in a variable f contained in a storage area in the memory 10 (Step 142). The function driven analyzer 43 conducts retrieval in a direction of arrows along edges of a graph on the physical model by taking physical data f as the starting point, obtains a set of paths starting from f and leading to an arbitrary vertex, and stores the set of the paths in a variable P contained in a storage area in the memory 10 (Step 143).

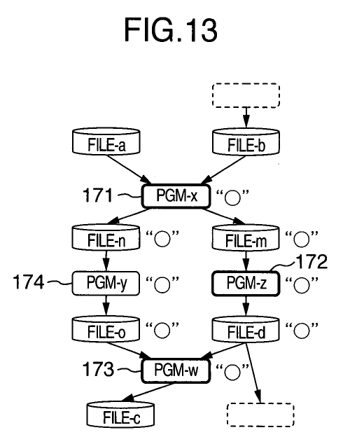

The function driven analyzer 43 takes one path from the set P of the paths obtained at Step 143, and stored the path in a variable p contained in a storage area in the memory 10 (Step 144). If the last vertex in the path p is contained in the program set F obtained at Step 141, the function driven analyzer 43 stores ◯ in the mark columns 64 and 66 of records associated with physical models (the program table 60 or the physical table 61) of all vertexes (programs or physical data) on the path P (Step 145). The function driven analyzer 43 conducts processing of Steps 144 and 145 on all paths contained in the variable P obtained at Step 143 (Step 146). In addition, the function driven analyzer 43 conducts processing at Steps 141 to 146 on all physical data contained in the set F obtained at Step 141 (Step 147). If processing is executed on the graph shown in FIG. 13 taking {PGM-x, PGM-z, PGM-w} as a set of programs, then ◯ is entered in the mark columns of records associated with “PGM-x, FILE-n, FILE-m, PGM-y, PGM-z, FILE-o, FILE-d, PGM-w” in the program table 60 and the physical data table 61 (Step 145). These vertexes are presumed to be associated with the specified business function.

Subsequently, the function driven analyzer 43 provides physical data that is included in physical data input or output by programs provided with the mark “◯” at Step 145 and (1) that is only input or output by a program provided with the mark “◯” or (2) that is input to a program that is not provided with the mark “◯”, with a mark “Δ” (Step 148). For example, in FIG. 13, the function driven analyzer 43 provides the FILE-a, FILE-b and FILE-c with the mark “Δ”. The vertexes provided with the mark become candidates for input and output data of the specified business function. Owing to the function driven analyzing described heretofore, subgraphs corresponding to the specified business function can be picked out.

Finally, the function driven analyzer 43 transmits a subgraph obtained by the processing conducted at Steps 141 to 148 to the display apparatus 32. The display apparatus 32 displays the subgraph of the processing result in the same way as FIG. 9 (Step 149). The user ascertains the display, and the function driven analyzer 43 conducts updating of the business model and association model.

### Second Embodiment

In the first embodiment, it is assumed that the physical data is directly associated with a data storage area of a record, a variable, a file and a table in a program. The embodiment method described above may be extended to the case where data having different contents of meaning is stored in the data storage area. As practical cases, it is assumed that data having different contents of meaning exists as different records in a file and that different types of data occupy the same memory area each time a program is executed.

Also in processing of the physical model, although the program is considered as the vertex of a graph, the embodiment may be extended to the case where a plurality of different functions exist mixedly in a program. Description will be made on the second embodiment by incorporating the description of the first embodiment.

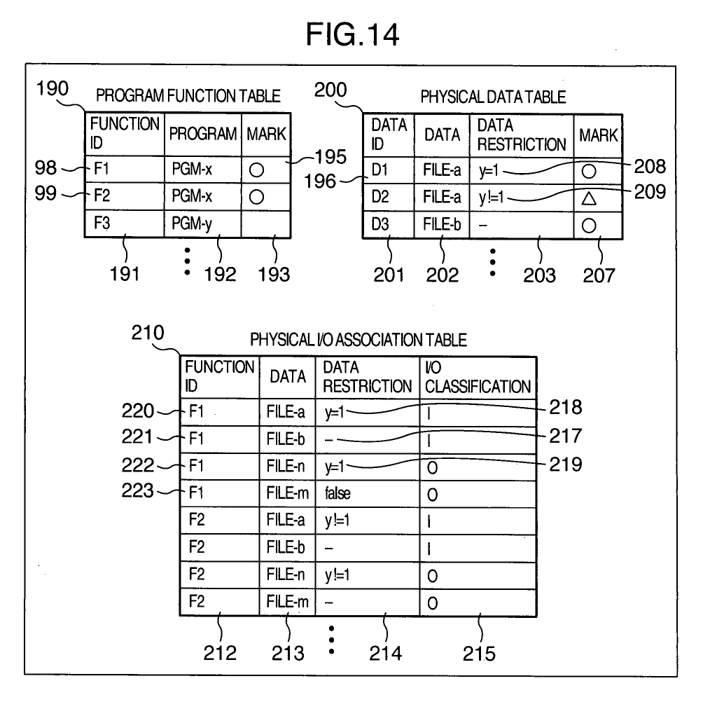

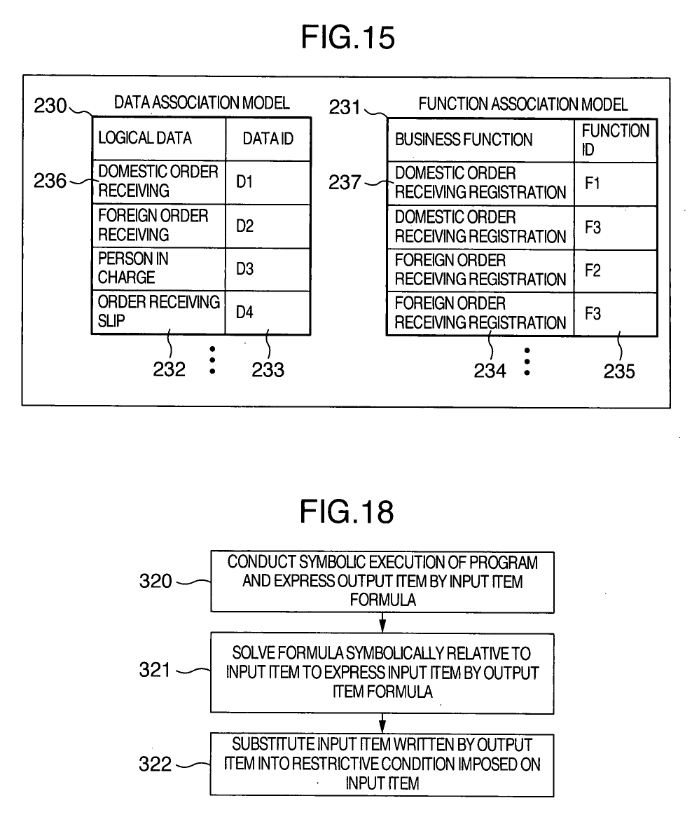

FIGS. 14 and 15 show the structure of tables extended for the purpose of realizing the second embodiment. A physical data table 200 shown in FIG. 14 is a substitute for the physical data table 61 in the physical model shown in FIG. 3. In addition to a data column 202 and a mark column 207 similar to those in the physical data table 37 shown in FIG. 3, a data ID column 201 and a data restriction column 203 are newly provided. A condition to be imposed on a record is loaded in the data restriction column 203 in order to distinguish between different types of records in the data storage area. The condition is expressed by an arithmetic equation, an inequality or a logical equation using the field of each record. For example, “y=1” 208 shown in FIG. 14 is a conditional equation imposed on a field y of a record to be stored in FILE-a. A record 196 represents data satisfying the conditional equation “y=1” in the data storage area of FILE-a. The data restriction may be “−” which means that no condition is imposed on the record.

Since the physical data is represented by a combination of a data storage area and a data restriction, the physical data is not determined unanimously only by the data storage area. The data ID column 201 is therefore provided as a new key for distinguishing among records.

A program function table 190 is a substitute for the table 60. The object of this table 190 is physical mount of processing for managing program functions similar to the table 60. A function ID column 191 is provided as a unique key of the table because a function cannot be specified unanimously among a plurality of functions in the same program only by the program name.

A physical I/O association table 210 is a substitute for the table 62 and represents association of an input with an output of the program function/physical data in the extended physical model.

The program function is represented by a function ID column 212. One record of the physical I/O association table 210 represents one input or output association of the program function with the data storage area. Data to be input and output is represented by a combination of a data column 213 and a data restriction column 214. Input/output is distinguished by an I/O classification column 215 similar to the first embodiment. The data restriction column 214 stores a restrictive condition for each storage area imposed on input or output data in the data column 213. It is assumed that the restrictive condition may take an arithmetic equation, an inequality or a logical equation using the field of each record, a special value “−” meaning that no condition is imposed on a field, or a special value “false” meaning that a record is not input or output.

A set of records having the same function ID writes all restrictions imposed on input/output items for the program function. For example, a set of records 220 to 223 writes restrictions imposed on input/output items for the program function with the function ID=F1. The data restriction column for input data stores the condition imposed on the input record of a program to distinguish among a plurality of different program functions contained in the program. A combination of a program and input restriction represents indirectly a portion of the program to be executed when the conditions are satisfied.

For example, the restrictive condition “y=1” 218 shown in FIG. 14 indicates a condition that “a field y of the input record a in FILE-a with the program function F1 is 1”, the restrictive condition “−” 217 indicates that “no condition is imposed on a record of FILE-b. Since the program PGM-x has the program function F1 as shown in the program function table 190, the records 220 and 221 represent a portion of the program PGM-x which is executed when the condition “y=1” is imposed on the input record of FILE-a.

Data restriction of output data is the restriction to be satisfied by the output data when the program is executed under a given input restriction.

For example, the restrictive condition “y=1” 219 indicates that “a field y of the input record in FILE-n with the program function F1 is 1”. The record 222 means that “the field y of FILE-n record which is an output of the program PGM-x is 1” on the condition assumption of an input of the program function F1. The data restriction column 214 of the record for FILE-m is “false” in the physical I/O association table 210, which means that there is no output for FILE-m on the same condition assumption.

FIG. 15 shows a data association model 230 and a function association model 231 provided for the physical model. These models are substitutes for the data association model 91 and function association model 92.

In the extended physical model of the second embodiment, a key for identifying the physical data is a data ID, and a key for identifying the program function is a function ID. A data ID column 233 and a function ID column 235 are therefore provided in the association model to represent association with the business model.

For example, a record 236 shown in FIG. 15 indicates that a data ID “D1” is associated with domestic order receiving data. D1 is shown in a record 196 of the physical data table 201 so that the domestic order receiving data is “data satisfying y=1 among data in FILE-a in the data storage area”.

A record 237 shown in FIG. 15 indicates that a function ID “F1” is associated with domestic order receiving registration. F1 corresponds to the function to be executed when the input record a in a program PGM-x satisfies y=1 as indicated by the program function table 190 and physical I/O association table 210.

Similar to the first embodiment, work starts in an initial state by assuming a model which can be estimated initially. In the second embodiment, the physical model cannot be generated perfectly only by analysis of the program. A precision of the model is raised gradually by interactive processing for adding information from the user, similar to the first embodiment.

Also in the system basing upon the extended model with restrictions, data driven analyzing and function driven analyzing can be conducted in a manner similar to the first embodiment. Because of a change in the physical model, the following description is incorporated basically for FIGS. 6, 11 and 12 and relevant drawings and description:

(1) The physical data corresponds to a combination of a data storage area and a restriction imposed on the data storage area, and is identified by the data ID in processing.

(2) The program corresponds to a combination of a physical program and a restriction imposed on an input of the program (program function), and is identified by the function ID in processing.

(3) If a path is traced from a vertex representing the physical data to a vertex representing the program function of inputting the physical data, a set of function IDs are acquired and only the vertexes corresponding to the set are coupled by arrows, the set satisfying:

(3-1) a program corresponding to a program function inputs data in a data storage area corresponding to the physical data, and

(3-2) both the restrictive condition imposed on the input item of the program corresponding to the program function and the restrictive condition imposed on the physical data are satisfied.

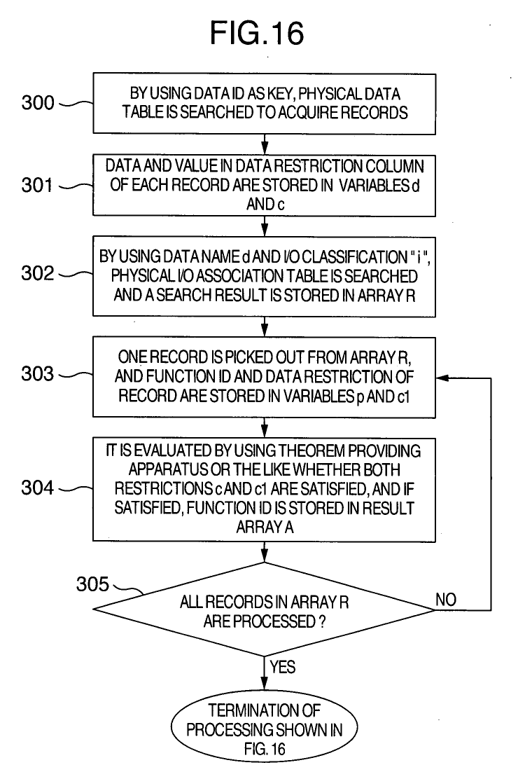

FIG. 16 shows processing of the system realizing the above operations.

(3-3) First, by using the data ID as a key, the physical data table 200 is searched to acquire records (Step 300).

(3-4) Data and a value in the data restriction column of each acquired record are stored in variables d and c (Step 301).

(3-5) By using the data name d and I/O classification “I”, the physical I/O association table 210 is searched, and a search result is stored in an array R (Step 302).

(3-6) One record is picked out from the array R, and the function ID and a value in the data restriction column of the record are stored in variables p and cl (Step 303).

(3-7) It is evaluated by using a theorem providing apparatus or the like whether both the restrictions c and cl are satisfied, and if satisfied, the function ID p is stored in a result array A (Step 304).

(3-8) The above-described operations are repeated until all records in the array R are processed (Step 305). After all records in the array R are processed, processing shown in FIG. 13 is terminated.

(4) If a path is traced from a vertex representing the program function to a vertex representing the physical data output from the program function, a set of data IDs are acquired and only the vertexes corresponding to the set are coupled by arrows, the set satisfying:

(4-1) a program corresponding to a program function outputs data in a data storage area corresponding to the physical data, and

(4-2) both the restrictive condition imposed on the output data storage area corresponding to the physical data and the restrictive condition imposed on the output item of the program function are satisfied.

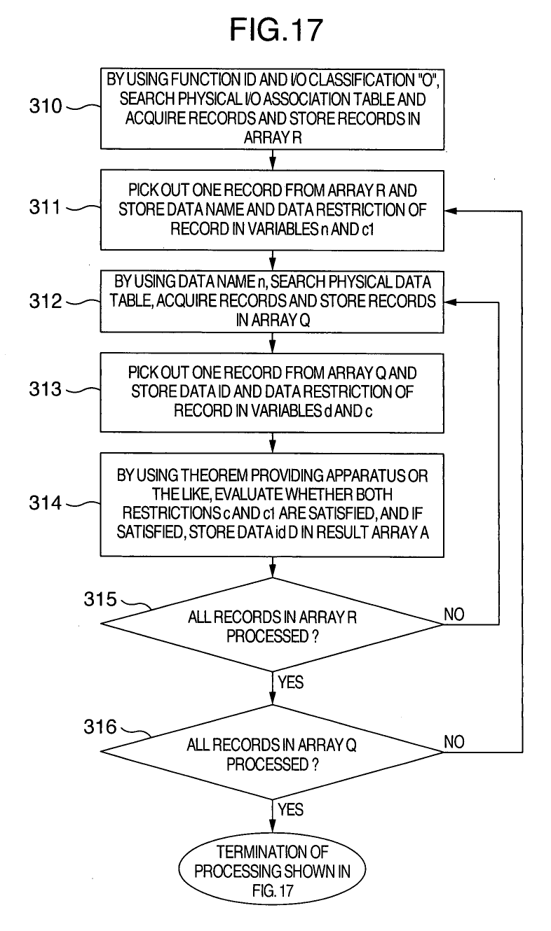

FIG. 17 shows processing of the system realizing the above operations.

(4-3) By using the given function ID and I/O classification “O”, the physical I/O association table 210 is searched to acquire records, and the records are stored in the array R (Step 310).

(4-4) One record is picked out from the array R, and a data name and a value in the data restriction column of each acquired record are stored in variables n and cl (Step 311).

(4-5) By using the data name n, the physical data table 200 is searched to acquire records, and the records are stored in an array Q (Step 312).

(4-6) One record is picked out from the array Q, and a data ID and a value in the data restriction column of the record are set to variables d and c (Step 313).

(4-7) It is evaluated by using a theorem providing apparatus or the like whether both the restrictions c and cl are satisfied, and if satisfied, the data ID d is stored in a result array A (Step 314).

(4-8) The above-described operations are repeated for all records in the arrays R and Q (Steps 315 and 316). After all records in the arrays Q and R are processed, processing shown in FIG. 17 is terminated. At Steps 304 and 314, there is a possibility that the system cannot judge whether both the restrictive conditions are satisfied. In this case, user judgement is input to establish the evaluation.

As described above, also in the system extending the physical model and program function to models with restrictions, the same data driven analyzing and function driven analyzing without restrictions can be conducted.

However, in order to efficiently operate the system using models with restrictions, it is necessary for the user to find restrictions imposed on the physical model and register the restrictions in the model. This modification of the physical model can be conducted interactively in a manner similar to modification of the business model and association model at Step 106 shown in FIG. 6. The system can support this modification by a model display function in the following manner. Evaluation of arrows between vortexes requiring the assumption of this processing can be conducted by using processing shown in FIGS. 16 and 17.

If there is physical data input or output from a plurality of functions, these functions and physical data are highlighted. Restrictions imposed on each input/output of the functions are displayed. For example, a worker studies division of the physical data by imposing a restriction on a data storage area by referring to the restriction imposed on each input/output of the functions.

(6) A function having an input or output from a plurality of physical data having different restrictions and the same data storage area is highlighted. Restrictions imposed on the plurality of physical data are displayed. For example, a worker studies imposing the restrictions imposed on data on each input/output of the functions.

(7) Under the given restriction imposed on an input, restriction imposed on output data of the program function is evaluated and displayed. It is assumed that this evaluation can be conducted by using already existing technologies. FIG. 18 shows a flow of processing. First, symbolic execution of the program is conducted to express an output item by an input item formula (Step 320). Next, the acquired formula is solved symbolically relative to the input item to express the input item by an output item formula (Step 321). Lastly, the input item written by the output item is substituted in the restrictive condition imposed on the input item (Step 322). This evaluation cannot be conducted depending upon the subject condition and program type in some cases. In such cases, the user is made to input evaluation.

Processing of model generation in the system supporting the extended model with restrictions will be described specifically by using following examples. In the following, mapping of the order receiving registration processing is made precise, and processing of domestic order registration is made understandable from data mapping processing. For example, it is first assumed that knowledge that a flag y in a record is 1 is obtained from information obtained from hearing with an end user of an analysis target system.

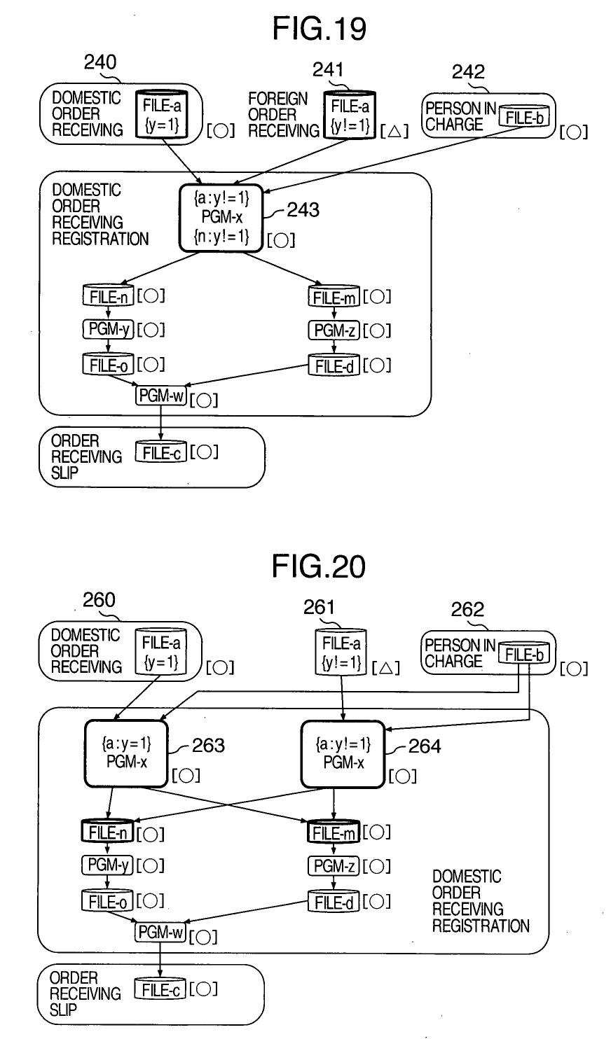

A worker using the embodiment system registers this knowledge in the system at Step 106 to use it as the restriction imposed on the record of FILE-a, and in the association model, the record on which the restriction y=1 is imposed is associated with domestic order receiving. In the business model, business of inputting domestic order receiving and outputting an order receiving slip is defined newly as a “domestic order receiving registration” function, and mapping was conducted again. FIG. 19 shows a result.

In this example, FILE-a was classified on the basis of data restriction and was displayed as icons 240 and 241. A conditional formula in { } of the icon indicates the restrictive condition imposed to each record.

The icon 240 pertains to domestic order receiving. The system highlights an icon of PGM-x because data having different restrictions and the same data storage area of FILE-a is input to PGM-x.

The user pays attention to inputs of highlighted PGM-x, and registers physical data restrictions y=1 and y!=1 as the restrictions imposed on the inputs of PGM-x to divide the function into two functions and conduct mapping again. FIG. 20 shows a result. Icons 263 and 264 represent two functions separated by designating the function of each input. A conditional formula written in { } above the program name in the icon represents a conditional formula imposed on the input of the program.

Icons of functions are merely copied at this time. Therefore, flows under the icons 263 and 264 are not easy to be observed. In order to analyze downstream flows, it is possible to instruct evaluation of execution results of the program functions corresponding to the icons 263 and 264.

For example, for the icon 263, an output of execution result of PGM-x is evaluated on the assumption that the input record satisfies the condition formula y=1. It is assumed that the condition formula y=1 is obtained for the output record n of PGM-x and that an output record m is not output. For the icon 264, an output of execution result of PGM-x is evaluated on the assumption that the input record satisfies the condition formula y!=1. It is assumed that the condition formula y!=1 is obtained for the output record n of PGM-x. Since these evaluations are not necessarily executable, a worker is required to supplement knowledge if not executable.

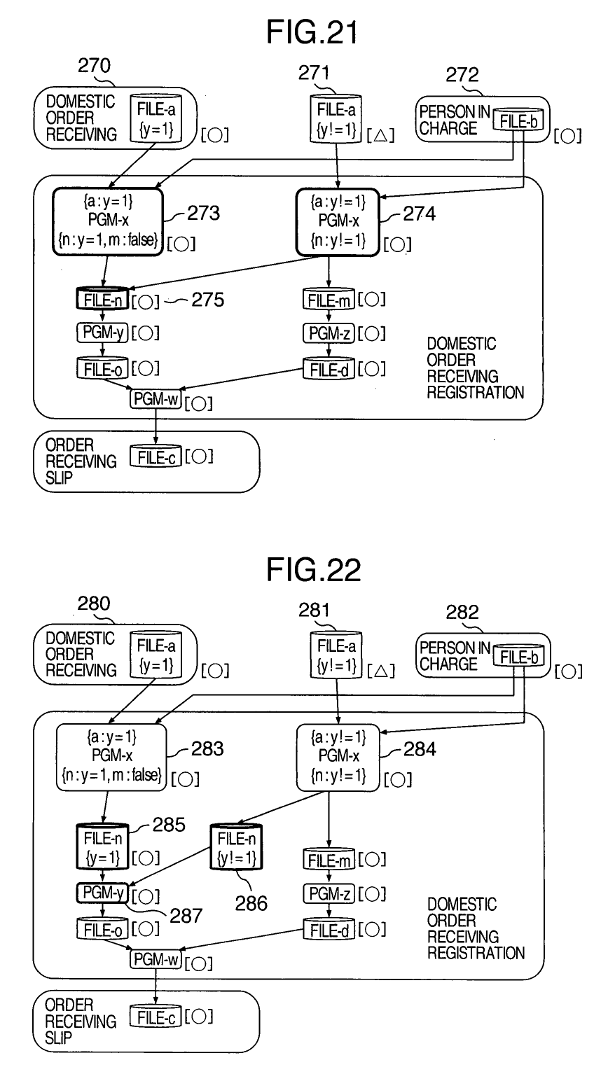

FIG. 21 shows the state that restrictions on output are evaluated. Icons 273 and 274 indicate program functions whose execution results were evaluated. The formula in { } under the program name in the icon is a condition formula of an output record. As described earlier, it is assumed that the condition formula “false” means that the record is neither input nor output. In this state, outputs from the two different program functions 273 and 274 having different restrictions are input to FILE-n 275 so that FILE-n is highlighted. The program functions 273 and 274 are also highlighted correspondingly.

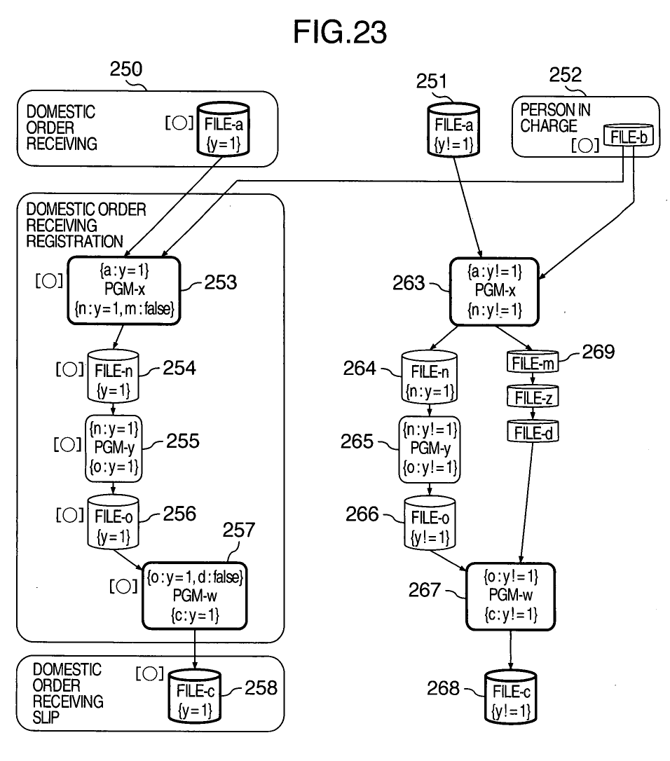

Next, the user pays attention to conditions imposed on outputs of a plurality of functions to the highlighted FILE-n 275 to impose the restriction condition on FILE-n and divide it into two physical data. FIG. 22 shows a result obtained by conducting mapping again after restriction is registered in FILE-n. Separated FILE-n is represented by icons 285 and 286. Similar to the above, restrictions of data are indicated by the condition formula in { } in the icons. Since data having different restrictions and the same data storage area of FILE-n is input to PGM-Y 287, it is highlighted. Interactive works of this type are continued to eventually obtain a mapping result such as shown in FIG. 23.

In the system having the configuration described above and in the embodiment using the extended model with restrictions, a portion regarding the “domestic order receiving registration” is extracted by order receiving registration processing so that programs and data regarding the “domestic order receiving registration” can be identified.

As described so far, the reverse engineering support system of the present invention can support a process of understanding an information system constituted of a number of programs by utilizing technologies of program analysis.

It should be further understood by those skilled in the art that although the foregoing description has been made on embodiments of the invention, the invention is not limited thereto and various changes and modifications may be made without departing from the spirit of the invention and the scope of the appended claims.

1. A reverse engineering support system for supporting to understand a program by analyzing the program used in an information system, wherein the reserve engineering support system is configured to:
store a business model which is a graph having business functions and logical data as vertexes and having directed edges representing input/output of data transferred between vertexes, a physical model which is a graph having program functions and physical data as vertexes and having directed edges representing input/output of data transferred between vertexes, and an association model which is an association table indicating association of each business function with each program function and association of each logical data with each physical data;
searche a set of physical data corresponding to logical data as input/output of each business function, for the business function specified by a user; and
calculate a subgraph of the physical model having the set as end points to infer a set of program functions corresponding to the business function.

2. The reverse engineering support system according to claim 1, if the subgraph having as the end points the set of physical data searched as corresponding to logical data as input/output of each business function does not exist in the physical model, a minimum subgraph is calculated having the set of physical data as a subset of physical data at end points of the subgraph to thereby infer a set of program functions corresponding to the business functions, data candidates lacking in the business or association model are displayed, and the user supports design decision on modifying the business or association model.

3. The reverse engineering support system according to claim 1, if the subgraph having as the end points the set of physical data searched as corresponding to logical data as input/output of each business function can be divided into a plurality of subgraphs using as end points the physical data belonging to the set of physical data, division into the subgraphs is displayed as a candidate for dividing the business function, and the user supports design decision on modifying the business or association model.

4. The reverse engineering support system according to claim 1, if there is a flow from a set of programs corresponding to the business function to the programs belonging to the original set via a program not belonging to the set, a minimum extension of the set of programs corresponding to the business functions and removing the flow is calculated to infer and display the set of programs corresponding to the business function, and the user supports design decision on associating the business function with the program and dividing the business function.

5. The reverse engineering support system according to claim 1, wherein the physical data as a vertex of the graph is represented by a combination of a data storage area and a restrictive condition to be satisfied by data stored in the data storage area, the program function as another vertex of the graph is represented by a combination of a program and a restrictive condition imposed on input and output items of the program, when a presence/absence of each edge between the physical data and program function is evaluated and when the program corresponding to the program function inputs or outputs the data storage area corresponding to the physical data, it is evaluated whether the data exists which satisfies both the restrictive condition imposed on data in the data storage area corresponding to the physical data and the restrictive condition imposed on the input or output item of the program corresponding to the program function, and if only the data exists, presence of the edge between vertexes is admitted.

6. The reverse engineering support system according to claim 1, wherein the business model, the physical model and the association model together with the subgraph of the business function inferred by the system are graphically displayed on a display apparatus, difference therebetween is presented to the user, and the user supports design decision on modifying the business model or association model.

7. The reverse engineering support system according to claim 5, wherein when the physical model is graphically displayed on a display apparatus and when the program function has an edge representing an input or output of a plurality of physical data having the same data storage area and different restrictive conditions imposed on the data in the data storage area, figures representative of the physical data and program function together with the restrictive conditions are displayed in a highlighted state.

8. The reverse engineering support system according to claim 5, wherein when the physical model is graphically displayed on a display apparatus and when a plurality of program functions having the same data program and different restrictive conditions imposed on an input or output item of the program have an edge representing an input or output of the same physical data, figures representative of the physical data and program functions together with the restrictive conditions are displayed in a highlighted state.

9. The reverse engineering support system according to claim 5, wherein the program corresponding to the program function as a vertex of the graph and an execution result of the program are evaluated under the condition imposed on the input item, to thereby evaluate a condition to be satisfied by the output item, and a candidate of the condition imposed to the output item of the program function is presented to the user.
